(19) United States
(12) Patent Application Publication
(10) Pub. No.: US 2014/0122701 A1
(43) Pub. Date: May 1, 2014

(54) Web Navigation Tracing

(71) Applicant: INTERNATIONAL BUSINESS MACHINES CORPORATION, Armonk, NY (US)

(72) Inventors: Melissa Jane Buco, Amawalk, NY (US); Shang Q. Guo, Cortland Manor, NY (US); Sinem Guven Kaya, New York, NY (US); Jonathan Lenchner, North Salem, NY (US); David M. Loewenstern, New York, NY (US); Larisa Shwartz, Scarsdale, NY (US)

(73) Assignee: INTERNATIONAL BUSINESS MACHINES CORPORATION, Armonk, NY (US)

(21) Appl. No.: 13/687,149

(22) Filed: Nov. 28, 2012

Related U.S. Application Data
(63) Continuation of application No. 13/664,821, filed on Oct. 31, 2012.

(51) Int. Cl. H04L 29/08

(52) U.S. Cl. CPC H04L 67/22
USPC 709/224

(57) ABSTRACT

A navigation to a plurality of visited web sites is traced and a navigation map is generated comprised of a node for each visited web site. Each node in the navigation map is connected by an edge to at least one other node in the navigation map, and the edge is associated with the link from the given visited web site to the next web site. For each visited web site, the corresponding node stores an address for the given web site, a time stamp of the visit to the given visited web site, a link from the given visited web site to a next web site and optionally a title of the web site. A keyword search of the nodes can be processed to identify a given web site in the navigation map. A signature portion of the given web site can be used to identify a new location of the given web site. A navigation map can be designated as a searchable public navigation map.

### CROSS-REFERENCE TO RELATED APPLICATION

This application is a continuation of U.S. patent application Ser. No. 13/664,821, filed Oct. 31, 2012, incorporated by reference herein.

The present application is related to U.S. Patent Application entitled “Improved Web Navigation Using Historic Navigation Patterns,” filed Oct. 31, 2012 and incorporated by reference herein.

### FIELD OF THE INVENTION

The present invention relates generally to the electrical, electronic and computer arts, and, more particularly, to techniques for tracing the navigation of a user on the Internet.

### BACKGROUND OF THE INVENTION

Browsers allow users to view web pages and other resources. The user specifies an address for the desired resource, such as a URL (Uniform Resource Locator), which directs the browser to the specified resource. The browser typically maintains a history of the resources that are visited, and provides tools that allow the user to review and revisit desired resources that were previously visited. Most browsers provide a “back” button and/or a historical list of visited web sites that allow a user to select a previously visited web site. In addition, most browsers allow a user to “bookmark” pages of particular interest.

A user may often discover an interesting web page or other resource during one or more browsing sessions as part of a research task. The user may subsequently wish to go back to the previously visited page only to discover that it cannot be found. Thus, if the user desires to revisit the same page at a later date, the user may have to employ a search engine to find the desired page. In addition, if a user wants to make notes or highlight portions of a web page, the user must make the notes using another tool, such as a word processing tool.

A need therefore exists for methods and apparatus for tracing web navigations. A further need exists for methods and apparatus for tracing web navigations that allow a user to return to specific previously visited resources, make notes or highlight things of interest, find new locations where previously visited pages have been relocated, and/or provide a surfing history hierarchy.

### SUMMARY OF THE INVENTION

Generally, methods and apparatus are provided for tracing web navigations. According to one aspect of the invention, a navigation by a user to a plurality of visited web sites is traced and a navigation map is generated. The navigation map is comprised of a node for each visited web site, wherein each node in the navigation map is connected by an edge to at least one other node in the navigation map, wherein the edge is associated with the link from the given visited web site to the next web site. For each visited web site, the corresponding node stores an address for the given web site, a time stamp of the visit to the given visited web site, a link from the given visited web site to a next web site and optionally a title of the web site. A keyword search of the nodes can be processed to identify the given web site in the navigation map.

According to a further aspect of the invention, a signature portion of the given web site can be identified and stored in the node for the given web site. A new location of the given web site can be identified using a web search based on the stored signature portion for the given web site. According to another aspect of the invention, one or more annotations of the given web site are obtained from the user and stored in the node for the given web site.

According to another aspect of the invention, a user can designate the navigation map as a public navigation map and the navigation map can be made available to at least one other user.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary web browsing session to which the present invention can be applied;

FIG. 2 illustrates exemplary pseudo code for a navigation map generation process that incorporates aspects of the present invention;

FIG. 3 illustrates another navigation map incorporating aspects of the present invention;

FIG. 4 illustrates a portion of an exemplary web page that can be visited by a user and included in a navigation map in accordance with the present invention;

FIG. 5 illustrates an exemplary data record corresponding to the node associated with the web page of FIG. 4;

FIG. 6 illustrates an exemplary browser interface for presenting a visited web page to a user; and

FIG. 7 depicts an exemplary web navigation tracing system that may be useful in implementing one or more aspects and/or elements of the present invention.

### DETAILED DESCRIPTION OF PREFERRED EMBODIMENTS

Aspects of the present invention provide methods and apparatus for tracing web navigations. According to one embodiment of the invention, a web navigations tracing tool is provided that allow a user to return to specific previously visited resources, make notes or highlight things of interest, find new locations where previously visited pages have been relocated (e.g., if a previously visited page is moved to a new address or location), and/or provide a surfing history hierarchy. Generally, as discussed hereinafter, as a user traverses web resources page by page, the tool automatically creates a “navigation map” storing certain information for each visited web page. The information stored in the navigation map for each visited web page can include, for example, metadata about the visited page, as well as user notes or highlights about the visited page.

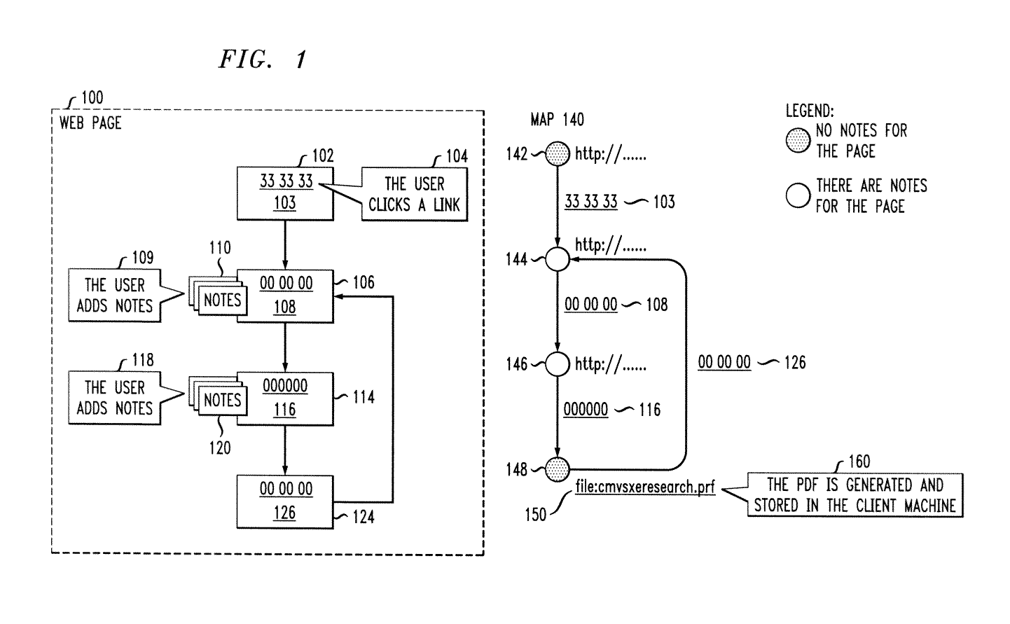

FIG. 1 illustrates an exemplary web browsing session 100 to which the present invention can be applied. It is noted that the exemplary web browsing session 100 for a given user can occur over one or more intervals of time and occur using different computing devices (not shown) of the given user. As shown in FIG. 1, the exemplary web browsing session 100 comprises a user visiting a first web page 102 containing a link 103 which the user selects at a time 104. The link 103 brings the user to a second web page 106 having a link 108. While browsing the second web page 106 the user enters notes 110 at a time 109. When the user selects the link 108, the browser brings the user to a third web page 114 having a link 116. While browsing the third web page 114 the user enters notes 120 at a time 118. When the user selects the link 116, the browser brings the user to a fourth web page 124 having a link 126. When the user selects the link 126, the browser returns the user to the second web page 106.

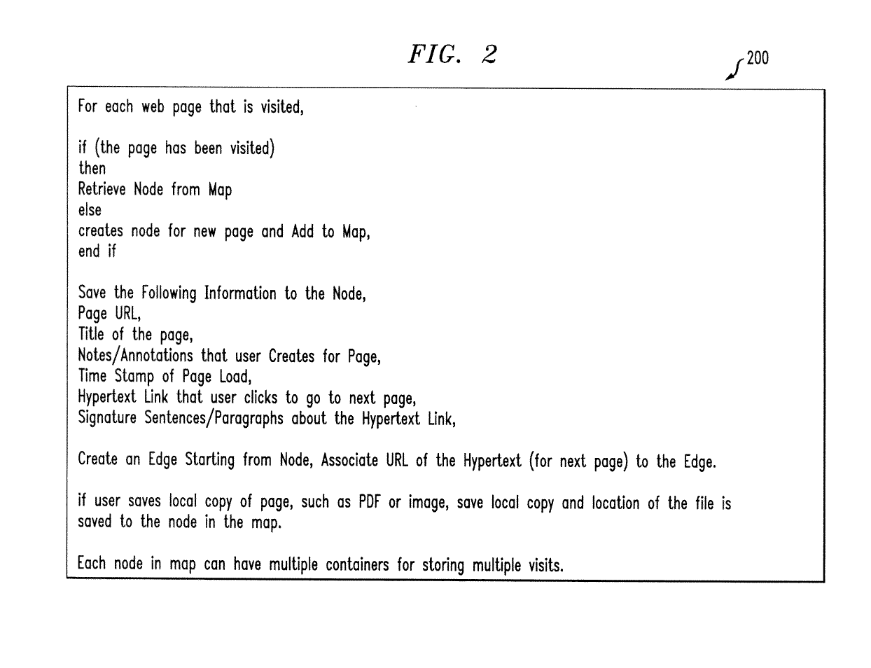

According to one aspect of the invention, a navigation map 140 is created for the exemplary web browsing session 100. Exemplary pseudo code for generating the navigation map 140 is discussed further below in conjunction with FIG. 2. The exemplary navigation map 140 indicates how the user gets to a given web page from the beginning of the browsing session 100. The exemplary navigation map 140 records the navigation process and contains information about each visited page and a transition trigger from one page to a subsequent page. In this manner, the user can trace back at any time to an earlier visited web page.

As shown in FIG. 1, the navigation map 140 comprises a node 142 corresponding to the user visit to the first web page 102, a second node 144 corresponding to the user visit to the second web page 106, a third node 146 corresponding to the user visit to the third web page 114, and a fourth node 148 corresponding to the user visit to the fourth web page 124. Each node 142, 144, 146, 148 represents a web page 102, 106, 114, 124, respectively, and is connected to a subsequent web page by an edge having a corresponding link 103, 108, 116, 126 that was used to navigate to the subsequent web page 102, 106, 114, 124. As indicated by the legend of FIG. 1, each node 142, 144, 146, 148 can optionally visually indicate whether there are user notes associated with the corresponding web page 102, 106, 114, 124.

In addition, according to a further aspect of the invention, discussed further below, the user can optionally generate PDF or another version of a visited web site and store it as part of the navigation map 140. For example, as shown in FIG. 1, when the user visits the fourth web page 124, the user can generate and store a PDF version of the web page 124 and a file identifier 150 indicating the location of the stored PDF can be included in the node 148 of the navigation map 140 associated with the web site 124.

The exemplary map 140 is presented as a directed graph, with each node representing a web page, and a label is associated with an edge out of the node is the hypertext link that is clicked to access the next web page (or next node in the map 140).

FIG. 2 illustrates exemplary pseudo code for a navigation map generation process 200 that incorporates aspects of the present invention. As shown in FIG. 2, for each visited web page, the exemplary navigation map generation process 200 determines if the web page has been visited. If the web page has been visited, then the navigation map generation process 200 retrieves the corresponding node from the navigation map 140. If the web page has not been visited, then the navigation map generation process 200 creates a new node in the navigation map 140 for the new page.

For each web site visit, the exemplary navigation map generation process 200 saves the following information to the node:
(i) page URL;
(ii) title of the page;
(iii) notes/annotations that user creates for page;
(iv) time stamp of page load;
(v) hypertext link that user clicks to go to next page; and
(vi) signature sentences/paragraphs about the hypertext link.

In addition, the exemplary navigation map generation process 200 creates an edge starting from the given node and associates the URL of the hypertext link (for the next page) to the edge.

If the user saves a local copy of the visited web page, such as a PDF or an image of the web page, the local copy is saved and the location of the file is saved to field 150 of the node in the navigation map 140. It is noted that in an exemplary embodiment, each node in the navigation map 140 can have multiple containers for storing multiple visits to the same web page (each uniquely identified by a time stamp).

The signature sentence(s) can also be used to validate an article returned by the URL link stored in the map 140. If the returned article does not match with the stored signature or the URL is broken, the signature sentence is used to search the Internet using, for example, a search engine. Once the new location is identified, the link of the node in the map 140 can be updated. The signature sentences/paragraphs can be selected by the system automatically, for example, using one or more paragraphs near the selected hypertext.

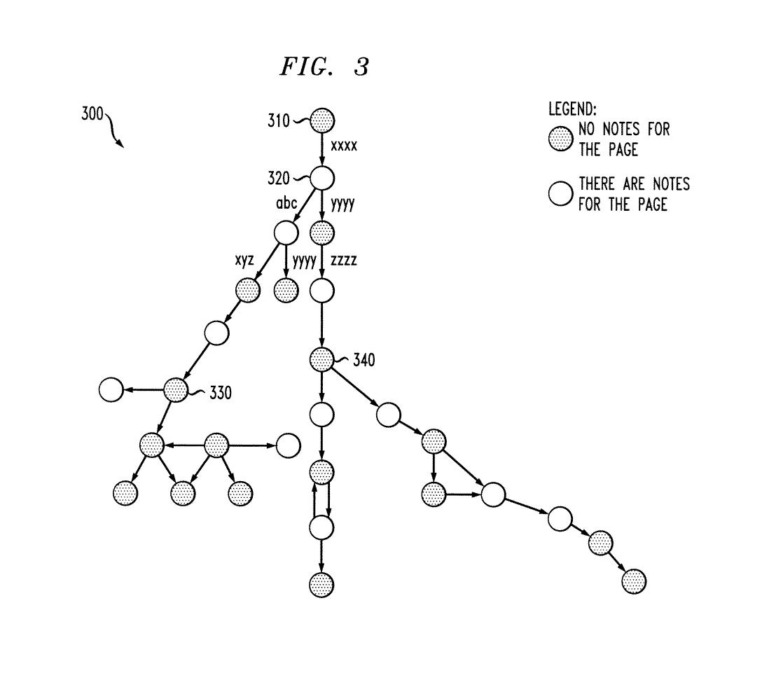

FIG. 3 illustrates another navigation map 300 incorporating aspects of the present invention. The exemplary navigation map 300 indicates how the user gets to a given web page from the beginning of the browsing session indicated by initial node 310. The exemplary navigation map 300 records the navigation process and contains information about each visited page and a transition trigger from one page to a subsequent page, in a similar manner to the navigation map 140 of FIG. 1.

As shown in FIG. 3, the navigation map 300 comprises a number of branch nodes, such as nodes 320, 330, 340, corresponding to pages that a user initially left and returned to before navigating to a different page (during the same or a different navigation session). Each node, such as nodes 310, 320, 330, 340 represents a visited web page, and is connected to a subsequent web page by an edge having a corresponding link that was used to navigate to the subsequent web page. Arrows 350 and 360 indicate an entry into a corresponding node within the navigation map 300 at the start of a new navigation session.

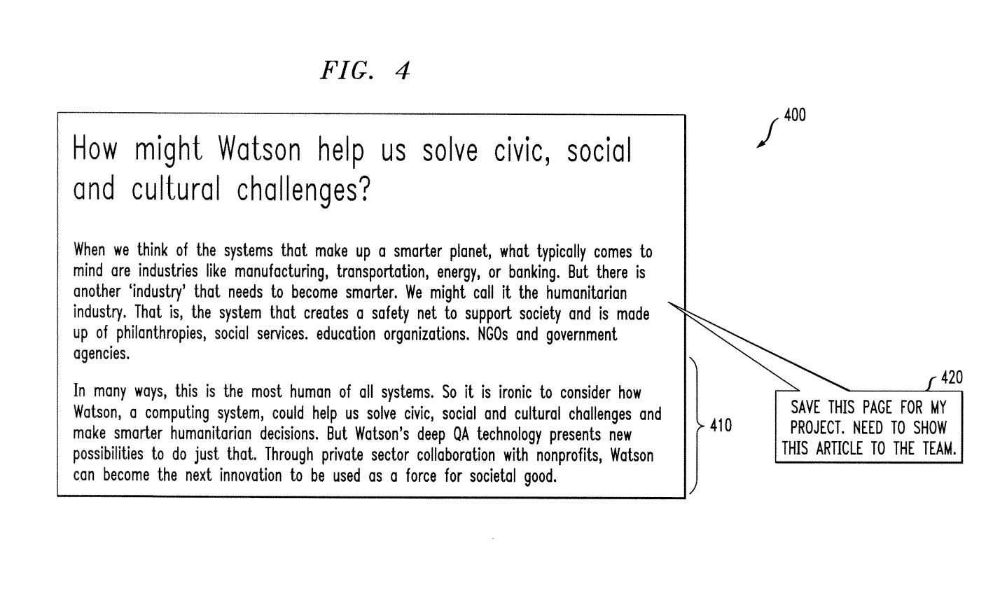

FIG. 4 illustrates a portion of an exemplary web page 400 that can be visited by a user and included in a navigation map 140 in accordance with the present invention. As shown in FIG. 4, the signature text 410 has been selected for the web page 400 and the user has provided a note 420 indicating “save this page for my project. Need to show this article to the team.”

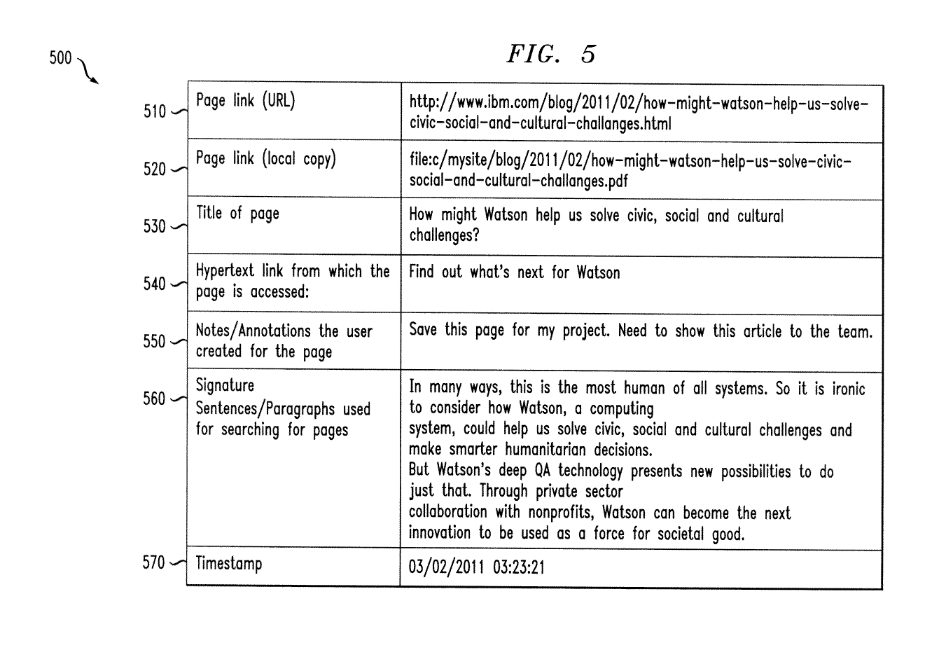

FIG. 5 illustrates an exemplary data record 500 corresponding to the node associated with the web page 400 of FIG. 4. As shown in FIG. 5, the exemplary data record 500 comprises the page link (URL) of the web page 400 in a field 510, the page link (local copy) of the web page 400 in a field 520, title of the web page 400 in a field 530, hypertext link from which the page 400 was accessed in a field 540, notes/annotations 420 the user created for the page 400 in a field 550, and signature sentences/paragraphs 410 from the page 400 used to search for the page 400 if the link is broken in a field 560 and a timestamp indicating when the web page was visited in a field 570.

The data record 500 is typically stored as part of the map 140 on the user's local machine when the user navigates to the web page 400. In a further variation, the navigation map 140 can be stored on a central server that is accessible by the associated authorized user from various systems/browsers. For example, the navigation map 140 can be provided to a user as a service. In this manner, a map 140, 300 is transferable between multiple machines and between browsers, optionally in a compressed and encrypted form.

According to a further aspect of the invention, a map 140, 300 can be designated as a public map that can be published by a server so subscribers of a service could use it. A public map can be downloaded, updated, retrieved and/or searched by multiple users. In one exemplary implementation, the map 140 is stored in the server's data store in the same way it is stored on the client without versioning support. In this case, a Publish service stores the information for each navigation map 140 in the data store without any references to any other possible versions or original ownership (created by).

In a further variation, subscribers can be provided with additional information on the navigation maps 140 such as previously published versions (parents/children) of this map 140 and their ownership. The differences relative to a prior version can be stored in the data store together with the reference to the parent map. In this manner, the maps can be composed from various versions of the same base map, thereby facilitating more efficient usage of storage.

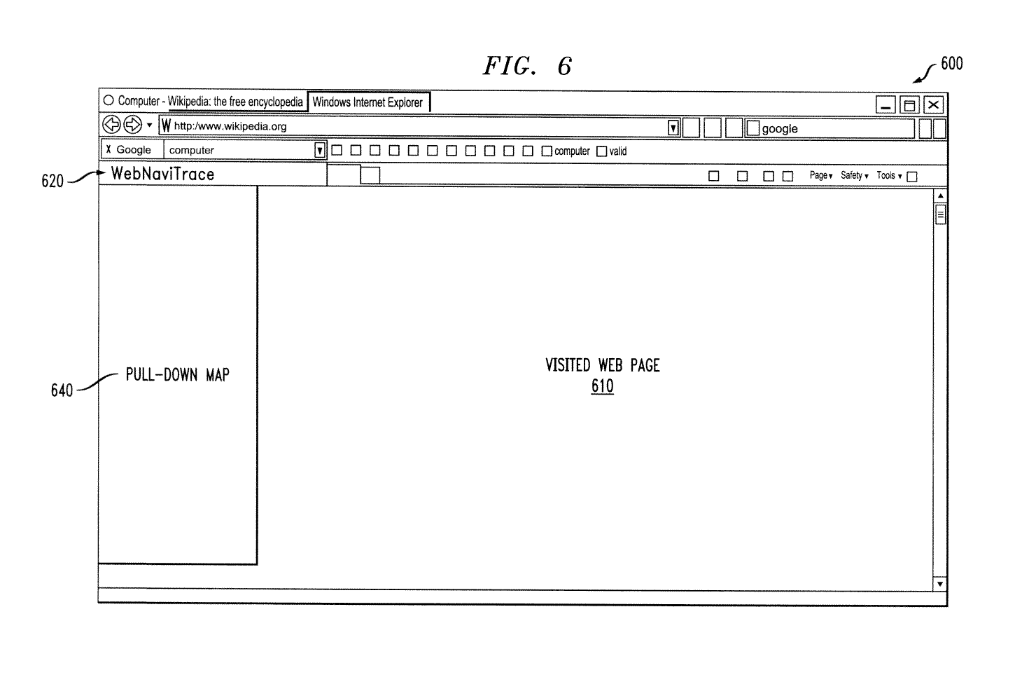

FIG. 6 illustrates an exemplary browser interface 600 for presenting a visited web page 610 to a user. As shown in FIG. 6, the exemplary browser interface 600 includes a WebNaviTrace button 620 that allows a user to access a pull down map 640 containing a navigation map such as the maps 140, 300 discussed above.

The map 140 can be visualized in the browser 600. Any previously visited document can be accessed by clicking on the corresponding node in the map 140 (e.g., based on the page link associated with the node).

The exemplary browser interface 600 can also facilitate searches of the navigation map 140 in page contents, notes/annotations, as well filtering, for example, based on authors, time range and versions.

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

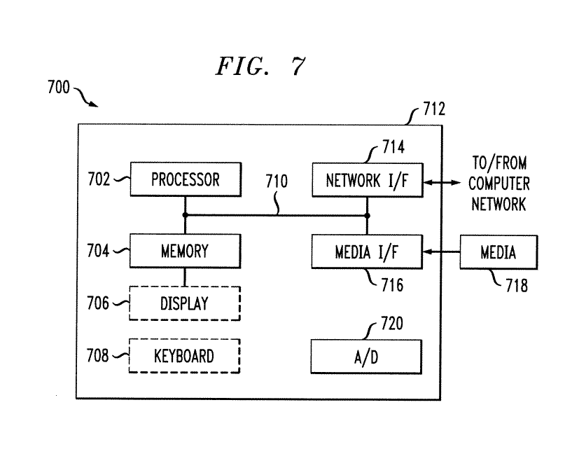

One or more embodiments can make use of software running on a general purpose computer or workstation. FIG. 7 depicts an exemplary web navigation tracing system 700 that may be useful in implementing one or more aspects and/or elements of the present invention. With reference to FIG. 7, such an implementation might employ, for example, a processor 702, a memory 704, and an input/output interface formed, for example, by a display 706 and a keyboard 708. The memory 704 may store, for example, code for implementing the layout process 300 of FIG. 3.

The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like.

In addition, the phrase “input/output interface” as used herein, is intended to include, for example, one or more mechanisms for inputting data to the processing unit (for example, mouse), and one or more mechanisms for providing results associated with the processing unit (for example, printer). The processor 702, memory 704, and input/output interface such as display 706 and keyboard 708 can be interconnected, for example, via bus 710 as part of a data processing unit 712. Suitable interconnections, for example via bus 710, can also be provided to a network interface 714, such as a network card, which can be provided to interface with a computer network, and to a media interface 716, such as a diskette or CD-ROM drive, which can be provided to interface with media 718.

Analog-to-digital converter(s) 720 may be provided to receive analog input, such as analog video feed, and to digitize same. Such converter(s) may be interconnected with system bus 710.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 702 coupled directly or indirectly to memory elements 704 through a system bus 710. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 708, displays 706, pointing devices, and the like) can be coupled to the system either directly (such as via bus 710) or through intervening I/O controllers (omitted for clarity).

Network adapters such as network interface 714 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 712 as shown in FIG. 7) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 718 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the FIGS. illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Method steps described herein may be tied, for example, to a general purpose computer programmed to carry out such steps, or to hardware for carrying out such steps, as described herein. Further, method steps described herein, including, for example, obtaining data streams and encoding the streams, may also be tied to physical sensors, such as cameras or microphones, from whence the data streams are obtained.

It should be noted that any of the methods described herein can include an additional step of providing a system comprising distinct software modules embodied on a computer readable storage medium. The method steps can then be carried out using the distinct software modules and/or sub-modules of the system, as described above, executing on one or more hardware processors 502. In some cases, specialized hardware may be employed to implement one or more of the functions described here. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural foims as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus for tracing a navigation by a user to a plurality of visited web sites, the apparatus comprising:
a memory; and
at least one hardware device, coupled to the memory, operative to:
for a given visited web site, store in a node for said given web site an address for said given web site, a time stamp of said visit to said given visited web site, and a link from said given visited web site to a next web site; and
generate a navigation map comprised of said nodes for said plurality of visited web sites, wherein each node in said navigation map is connected by an edge to at least one other node in said navigation map, wherein said edge is associated with said link from said given visited web site to said next web site.

2. The apparatus of claim 1, wherein said node further comprises a title of said given web site.

3. The apparatus of claim 1, wherein said at least one hardware device is further configured to identify a signature portion of said given web site and storing said signature portion in said node for said given web site.

4. The apparatus of claim 1, wherein said at least one hardware device is further configured to identify a new location of said given web site using a web search based on said stored signature portion for said given web site.

5. The apparatus of claim 1, wherein said at least one hardware device is further configured to obtain one or more annotations of said given web site from said user and storing said annotations in said node for said given web site.

6. The apparatus of claim 1, wherein said at least one hardware device is further configured to process a keyword search of said nodes to identify said given web site in said navigation map.

7. The apparatus of claim 1, wherein said at least one hardware device is further configured to receive a designation of said navigation map as a public navigation map and make said navigation map available to at least one other user.
